(19) United States
(12) Patent Application Publication
(10) Pub. No.: US 2020/0135059 A1
(43) Pub. Date: Apr. 30, 2020

(54) LASER-MARKABLE ARTICLE WITH CUSTOMIZED WATERMARKS AND PREPARATION METHOD THEREOF

(71) Applicant: 3M INNOVATIVE PROPERTIES COMPANY, St. Paul, MN (US)

(72) Inventor: Jiazhi Zhang, Shanghai City (CN)

(21) Appl. No.: 16/619,425

(22) PCT Filed: May 30, 2018
(86) PCT No.: PCT/IB2018/053854

§ 371 Date: Dec. 4, 2019

(30) Foreign Application Priority Data
Jun. 5, 2017 (CN) 201710413333.0

(51) Int. Cl. G09F 3/00; G09F 3/10; B23K 26/362; C09J 201/02

(52) U.S. Cl. CPC G09F 3/0294; G09F 3/10; B23K 26/362; G09F 2003/0276; C09J 2201/606; C09J 2203/334; C09J 201/02

(57) ABSTRACT

The present disclosure provides a laser-markable article with customized watermarks and a preparation method thereof. The laser-markable article with customized watermarks comprises a surface layer (1) containing a first coloring agent, a bottom layer (2) containing a second coloring agent, an adhesive layer (3), and an optional release layer (4) arranged consecutively in a stack, and further comprises customized watermarks (5′,5″) arranged in the surface layer (1), wherein the customized watermarks (5′,5″) are comprised of a plurality of watermark units spaced apart from one another and regularly distributed in the surface layer (1), and each watermark unit is comprised of a laser-etched pattern with an etch depth of 2.5 to 25 micrometers. The laser-markable article with customized watermarks have good abrasive resistance, durability, and appearance effects.

### TECHNICAL FIELD

The present disclosure relates to a laser-markable article, and in particular, to a laser-markable article with customized watermarks that can be used as a label and a preparation method thereof.

### BACKGROUND

A label with a vehicle identification code is an important part of a vehicle and is of great importance in terms of managing and tracking of the vehicles. In general, other than main information about parameter settings of the vehicle itself included in the labels, such labels are further required to carry customized information about the car manufacturers and the like. Information as such helps to managing and identifying vehicles in a fast manner. At the same time, the customized information also helps to improve anti-counterfeiting of the labels. The customized information, which can also be referred to as a watermark, fills the whole space of the label in a repeated format, and is used as the background of the label. The presence of the watermark information does not influence the reading of the main information about the vehicle that is prepared subsequently. After the main information is prepared, the watermark information can still be read clearly. Specific content of these watermarks may be, for example, a Chinese name, logo, or brand and the like of the car manufacturers. Generally, the watermark information is customized on the label material in advance by the manufacturer producing such label materials based on the requirements of the car manufacturers. Then such label material is supplied to the car manufacturers. In the vehicle production line of the plant of the car manufactures, main information about vehicles are written onto the label material on-site according to the models and codes of the vehicles produced of the day. Regarding labels used in such application, these labels are required to have excellent properties such as abrasion resistance, aging resistance, and chemical solvent corrosion resistance. As an important component of the labels, the customized watermark is also required to have these properties. At present, every country has its relevant standards. Such description can also be found in related national standards of China: the customized information about the car manufactures on a label shall still be visible after using an abrasion wheel of CS-10 on a Taber abrasion tester at a load of 500 g and 200 revolutions.

Currently, customized watermarks are prepared mainly by printing solvent-type or UV-type ink on such labels. However, in such a printing technology, it is required to apply heat or UV energy to cure the ink, causing a risk of changing properties of the label. For example, contraction of the surface material of the label, curling of a release paper of the label due to water loss, or influences on the adhesive effect of the adhesive, and the like may occur. Another more pressing issue is that such labels produced with customized information have poor abrasion resistance, chemical solvent resistance, durability, and the like. Additionally, labels prepared through the above method has the problem that the order minimum quantity tends to be large which in turn results in overstock. Even though an impression mode is adopted to overcome the problems of abrasion resistance and durability, this mode also has the problems of huge production requirement, low efficiency, high production cost, and overstock issue, which are not favored by car manufactures with low amount of label-use needs.

### SUMMARY

The present disclosure provides a laser-markable article with customized watermarks having good abrasion resistance, durability, and appearance effects, and further provides a method for preparing the laser-markable article with customized watermarks.

Some aspects of the present disclosure provide a laser-markable article with customized watermarks, comprising a surface layer containing a first coloring agent, a bottom layer containing a second coloring agent, an adhesive layer, and an optional release layer arranged consecutively in a stack, wherein the laser-markable article further comprises customized watermarks arranged in the surface layer, the customized watermarks are comprised of a plurality of watermark units spaced apart from one another and regularly distributed in the surface layer, and each watermark unit is comprised of a laser-etched pattern with an etch depth of 2.5 μm to 25 μm.

Some aspects of the present disclosure provide a method for preparing a laser-markable article with customized watermarks, comprising: laser-etching the surface layer of the laser-markable article to form customized watermarks, an etch depth is from 2.5 μm to 25 μm.

### BRIEF DESCRIPTION OF THE DRAWINGS

In order to make the above noted and other purposes, characteristics and advantages of the present disclosure more apparent and easier to understand, the present disclosure is further explained in combination with the appended figures and the detailed description below.

FIG. 1 is a structural representation of a laser-markable article with customized watermarks according to certain embodiments of the present disclosure.

FIG. 2 shows a front view of a laser-markable article with customized watermarks according to one embodiment of the present disclosure.

FIG. 3 shows the appearance of a sample prepared in Example 1 of the present disclosure after the Taber abrasion resistance test.

FIG. 4 shows the appearance of a sample from Comparative example 1 of the present disclosure after the abrasion resistance test.

FIG. 5 shows watermark units of a sample from Comparative example 2 of the present disclosure.

### DETAILED DESCRIPTION

It should be appreciated that a person skilled in the art can devise various other implementation schemes based on the teachings of this Description and modify these without departing from the scope or spirit of the present disclosure. Therefore, the following particular embodiments have no limiting meaning.

Unless otherwise specified, all numbers used in this Description and the Claims representing the characteristic sizes and quantities and physical properties should be understood as being modified by the term “approximately” under any and all circumstances. Therefore, unless stated on the contrary, parameters in numerical values listed in the above description and in the attached claims are all approximate values, and those of skill in the art are capable of seeking to obtain desired properties by taking advantage of contents of the teachings disclosed herein, and changing these approximate values appropriately. The use of a numeric value range represented by endpoints includes all numbers within such range and any range within such range, e.g., 1 to 5 includes 1, 1.1, 1.3, 1.5, 2, 2.75, 3, 3.80, 4, and 5 etc.

Unless specified otherwise, the “watermark” as stated in the present disclosure refers to customized information filling the whole background space in a repeated format. The presence of the watermark information does not influence the reading of the main information about the vehicle that is prepared subsequently. After the main information is prepared, the watermark information can still be read clearly.

Unless specified otherwise, the “watermark units” as stated in the present disclosure refer to the same basic units constituting the watermarks; these units are distributed and spaced regularly from one another.

Unless specified otherwise, the “main information” as stated in the present disclosure refers to main information carried on the marked article. For example, for a vehicle label, the main information may include a vehicle identification code, parameter settings of the vehicle itself, and the like.

Unless specified otherwise, the “surface layer” as stated in the present disclosure refers to an exposed surface located on the outer side of the laser-markable article or label when it is attached to an object.

Laser-Markable Article with Customized Watermarks

According to certain aspects, the present disclosure provides a laser-markable article with customized watermarks, comprising a surface layer containing a first coloring agent, a bottom layer containing a second coloring agent, an adhesive layer, and an optional release layer arranged consecutively in a stack, wherein the customized watermarks are arranged in the surface layer.

Customized Watermarks

The customized watermarks in the laser-markable article provided herein may be comprised of a plurality of watermark units spaced apart from one another and distributed regularly in the surface layer. Each watermark unit is comprised of a laser-etched pattern with an etch depth of 2.5 μm to 25 μm. Customized watermarks with an etch depth of 2.5 μm to 25 μm have a good watermark appearance with excellent abrasion resistance and durability that does not affect subsequent preparation of the main information.

According to certain specific embodiments, the etch depth of watermark units is less than the thickness of the surface layer; for example, the etch depth may be 3 μm to 10 μm. Under this circumstance, the bottom layer located under the surface layer is not exposed.

According to certain specific embodiments, a portion of the pattern of the watermark unit may have a depth greater than the thickness of the surface layer but not more than the total thickness of the surface layer and the bottom layer. The area of the pattern with a depth greater than the thickness of the surface layer accounts for not more than 20%, e.g., about 10%, about 8%, about 5%, about 3%, about 1%, and the like in each watermark unit. Under the circumstance where the area of the pattern with a depth greater than the thickness of the surface layer does not account for more than 20% in each watermark unit, the subsequent preparation of main information on the bottom layer is not influenced.

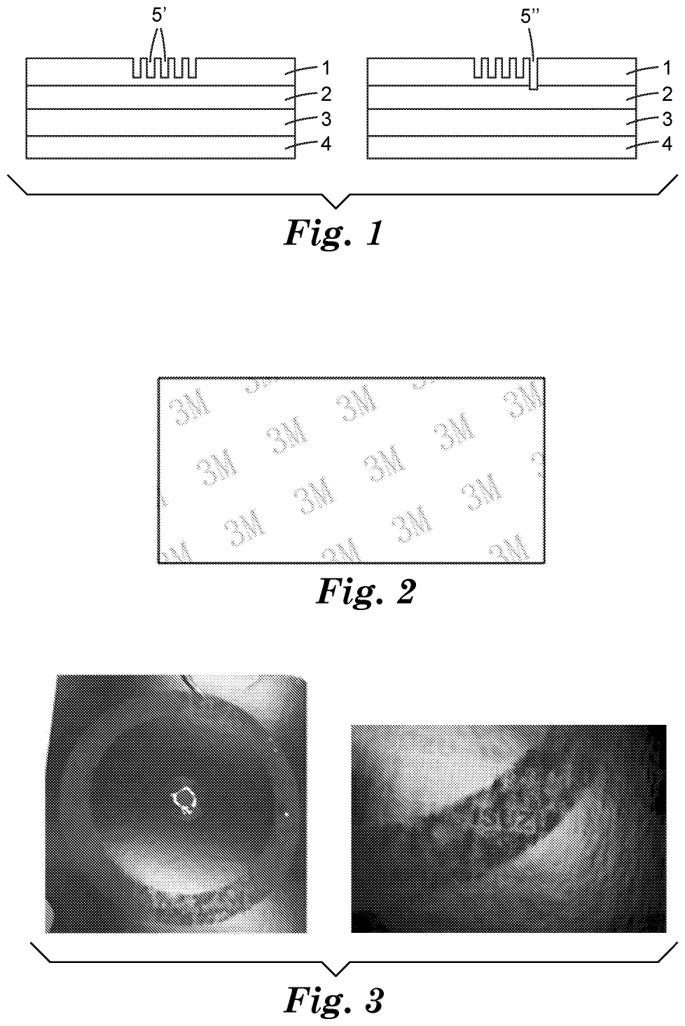

FIG. 1 is a structural representation of a laser-markable article with customized watermarks according to certain embodiments of the present disclosure. A surface layer 1 containing a first coloring agent, a bottom layer 2 containing a second coloring agent, an adhesive layer 3 and a release layer 4 are arranged consecutively in a stack; and customized watermarks 5′ and 5″ are formed in the surface layer 1, wherein 5′ shows the situation where the etch depth of the watermark is less than the thickness of the surface layer 1; and 5″ shows the situation where the etch depth of a portion of the pattern of the watermark is greater than the thickness of the surface layer 1.

FIG. 2 shows a front view of a laser-markable article with customized watermarks according to one embodiment of the present disclosure, wherein the customized watermarks spread all over the laser-markable article, and the watermark units (3M labels in the figure) are spaced apart from one another and distributed regularly.

According to certain specific embodiments, the pattern of the watermark unit may be comprised of dots and/or lines, wherein the spacing between dots and/or lines may be within a range from 0 μm to 1.5 mm, e.g., from 0 μm to 1.0 mm, or from 0 μm to 500 μm.

Surface Layer and Bottom Layer

According to certain specific embodiments, the first coloring agent contained in the surface layer and the second coloring agent contained in the bottom layer may be two coloring agents forming certain color contrast, such as a black coloring agent and a white coloring agent. In a certain specific embodiment, the first coloring agent is a black coloring agent and the second coloring agent is a white coloring agent. In another specific embodiment, the first coloring agent is a white coloring agent and the second coloring agent is a black coloring agent.

According to certain specific embodiments, the thickness of the surface layer may be within a range from 2 μm to 25 μm, e.g., from 5 μm to 20 μm, 5 μm to 15 μm or about 10 μm. The thickness of the bottom layer may be within a range from 30 μm to 100 μm, e.g., from 50 μm to 70 μm, or about 50 μm. Thickness of the surface layer and the bottom layer within the above ranges allows the whole laser-markable article to have excellent abrasion resistance and durability even after the main information is prepared thereon.

According to certain specific embodiments, the surface layer and the bottom layer are formed respectively by a resin composition containing a first coloring agent and a resin composition containing a second coloring agent. In addition to the coloring agents contained, the compositions of the resin compositions for forming the surface layer and the bottom layer may be the same, such that higher adhesion can be obtained between the surface layer and the bottom layer, thereby avoiding the layering or stripping phenomenon. In a certain specific embodiment, the resin compositions for forming the surface layer and the bottom layer comprise polyvinyl butyral, a polyester resin, and a curing agent for film formation. The use of polyvinyl butyral allows the surface layer and the bottom layer to be fragile (when the surface layer and/or the bottom layer are/is stripped off, it is difficult to keep the stripped layer intact), which improves the anti-falsification property of the laser-markable article. The polyester resin may be any polyester comprising at least two crosslinkable groups, e.g., hydroxy groups; as long as the polyester is compatible with polyvinyl butyral and can form a film, that will suffice. Examples include saturated polyesters, unsaturated polyesters, alcohol-acid polyesters, polycarbonates, and the like. The curing agent for film formation may be crosslinkable resins containing OH groups, including aziridine, isocyanate, amines, melamine or melamine resins, and the like. Commercially available curing agents for film formation can be used, e.g., Cymel 325 from Cytec Industries Corporation, etc.

No special requirement is needed for contents and proportions of various components in the surface layer and the bottom layer. Generally, polyvinyl butyral and the polyester resin can be used in a proportion by mass of 10:90 to 90:10, e.g., 30:70 to 70:30, or 40:60 to 60:40, or about 50:50. The curing agent for film formation may account for 5% or more and 50% or less, e.g., 10% to 40%, 15% to 30%, etc. based on the total solid content in the resin composition. The coloring agent may account for 10% to 40%, e.g., 15%-30%, etc. based on the total solid content in the resin composition. Coloring agents within the content ranges may ensure the color presence on the surface layer or the bottom layer, and maintaining strength of the surface layer or the bottom layer at the same time.

Adhesive Layer

In the laser-markable article of the present disclosure, no special limitation is posed on the adhesive layer. As long as the adhesive layer can provide adequate adhesive force when the laser-markable article is attached to the object, that will suffice.

According to certain specific embodiments, the adhesive in the adhesive layer may be a pressure-sensitive adhesive. Specific examples of the pressure-sensitive adhesive include acrylic pressure-sensitive adhesives, synthetic rubber or natural rubber pressure-sensitive adhesives, polyurethane pressure-sensitive adhesives, organosilicon pressure-sensitive adhesives, and the like.

Release Layer

In the laser-markable article of the present disclosure, no special limitation is posed on the release layer. Any release layer may be used, such as silicon release layer.

Method for Preparing Laser-Markable Article with Customized Watermarks

According to certain aspects, the present disclosure provides a method for preparing a laser-markable article with customized watermarks, the method comprises: laser-etching the surface layer of the laser-markable article to form customized watermarks, an etch depth is from 2.5 μm to 25 μm.

Before laser-etching the surface layer of the laser-markable article, the method may further comprise the following steps: forming a surface layer containing a first coloring agent on a carrier film; forming a bottom layer containing a second coloring agent on the surface layer; forming an adhesive layer optionally with a release layer on the bottom layer; and stripping off the carrier film.

According to certain specific embodiments, the forming of a surface layer of the first coloring agent on the carrier film comprises: dissolving a resin composition containing the first coloring agent, polyvinyl butyral, a polyester resin, and a curing agent for film formation into a solvent, followed by coating the solvent onto the carrier film.

According to certain specific embodiments, the forming of a bottom layer of the second coloring agent on the surface layer comprises: dissolving a resin composition containing the second coloring agent, polyvinyl butyral, a polyester resin, and a curing agent for film formation into a solvent, followed by coating the solvent onto the surface layer.

Regarding the description of the surface layer and the bottom layer, reference may be made to the “-Surface layer and bottom layer-” section above. Note that the thickness of the surface layer and the bottom layer refers to the thickness after drying of the coating.

According to certain specific embodiments, the solvent for dissolving various components of the resin compositions may be an organic solvent, including one organic solvent or a mixture of multiple organic solvents. In a specific embodiment, the organic solvent may be a mixed solvent of xylene and butanol.

According to certain specific embodiments, the carrier film on which the surface layer is formed may be in the form of a film or paper, and may or may not have a release layer. A polyester resin film and the like can be listed as an example of the carrier film. A silicon release layer and the like can be listed as an example of the release layer.

According to certain specific embodiments, methods for coating the surface layer and coating the bottom layer may include blade coating, slit coating, screen roller coating, and the like.

According to certain specific embodiments, after the resin composition is coated, the method further comprises a step of drying the coating. Drying temperature can be determined according to factors such as the solvent employed and the composition of the resin composition, and can be, for example, 100 to 300° C. or 120 to 250° C.

According to certain specific embodiments, the formation of the adhesive layer on the bottom layer may comprise coating an adhesive on the surface of the bottom layer directly, or may comprise coating the adhesive onto the release layer first, and then combining the release layer with the adhesive onto the bottom layer in a manner that allows the adhesive to contact the bottom layer.

Regarding the adhesive and the release layer herein, reference can be made to the related description in the “-Adhesive layer-” and “-Release layer-” above.

According to certain specific embodiments, the customized watermarks are formed in the surface layer by laser-etching.

Regarding the description of customized watermarks, reference can be made to the “-Customized watermark-” section above.

According to certain specific embodiments, a laser source employed for the laser-etching may be a CO₂, Nd-YAG, or UV laser source. The laser source and laser wavelength employed can be determined according to the components of the resin composition in the surface layer and the like. Also, the depth of a pattern of the customized watermarks can be adjusted by controlling the laser energy and the irradiation time. For example, the laser energy may be 5 to 15 W.

Application of Laser-Markable Articles

According to certain specific embodiments, the laser-markable article with customized watermarks of the present disclosure can be used as a label, such as a label for carrying a vehicle identification code, and the like.

The following specific embodiments are used to explain the present disclosure exemplarily but not restrictively.

Specific embodiment 1 is a laser-markable article with customized watermarks, comprising a surface layer containing a first coloring agent, a bottom layer containing a second coloring agent, an adhesive layer and an optional release layer arranged consecutively in a stack, wherein the laser-markable article may further comprise customized watermarks arranged in the surface layer, the customized watermarks are comprised of a plurality of watermark units spaced apart from one another and regularly distributed in the surface layer, and each watermark unit is comprised of a laser-etched pattern with an etch depth of 2.5 μm to 25 μm.

Specific embodiment 2 is the laser-markable article with customized watermarks according to specific embodiment 1, wherein the depth of the watermark unit is less than the thickness of the surface layer, or the depth of a portion of the pattern in the watermark units is greater than the thickness of the surface layer but not more than the total thickness of the surface layer and the bottom layer, and an area of the pattern with a depth greater than the thickness of the surface layer accounts for not more than 20% in each watermark unit.

Specific embodiment 3 is the laser-markable article with customized watermarks according to specific embodiment 1 or 2, wherein the pattern of the watermark units is comprised of dots and/or lines, with a spacing between the dots being from 0 μm to 1.5 mm.

Specific embodiment 4 is the laser-markable article with customized watermarks according to any one of specific embodiments 1 to 3, wherein the first coloring agent and the second coloring agent are two contrasting coloring agents.

Specific embodiment 5 is the laser-markable article with customized watermarks according to any one of specific embodiments 1 to 4, wherein the first coloring agent is a black coloring agent, and the second coloring agent is a white coloring agent.

Specific embodiment 6 is the laser-markable article with customized watermarks according to any one of specific embodiments 1 to 5, wherein the surface layer has a thickness of 2 μm to 25 μm.

Specific embodiment 7 is the laser-markable article with customized watermarks according to any one of specific embodiments 1 to 6, wherein the bottom layer has a thickness of 30 μm to 100 μm.

Specific embodiment 8 is the laser-markable article with customized watermarks according to any one of specific embodiments 1 to 7, wherein the surface layer and the bottom layer are formed by resin compositions containing a first coloring agent and a second coloring agent respectively.

Specific embodiment 9 is the laser-markable article with customized watermarks according to specific embodiment 8, wherein the resin compositions further comprise polyvinyl butyral, a polyester resin, and a curing agent for film formation.

Specific embodiment 10 is the laser-markable article with customized watermarks according to any one of specific embodiments 1 to 9, wherein the adhesive layer is a pressure-sensitive adhesive layer.

Specific embodiment 11 is the laser-markable article with customized watermarks according to any one of specific embodiments 1 to 10, wherein the laser-markable article with customized watermark is used as a label having a vehicle identification code.

Specific embodiment 12 is a method for preparing the laser-markable article with customized watermarks according to any one of specific embodiments 1 to 11, the method comprising: forming a surface layer containing a first coloring agent on a carrier film; forming a bottom layer containing a second coloring agent on the surface layer; forming an adhesive layer optionally with a release layer on the bottom layer; stripping off the carrier film; and laser-etching the surface layer to form customized watermarks with an etch depth of 2.5 μm to 25 μm.

Specific embodiment 13 is the method according to specific embodiment 12, wherein the forming of a surface layer of the first coloring agent on the carrier film comprises: dissolving a resin composition containing the first coloring agent, polyvinyl butyral, a polyester resin, and a curing agent for film formation into a solvent, followed by coating the solvent onto the carrier film.

Specific embodiment 14 is the method according to specific embodiment 12 or 13, wherein the forming of a bottom layer of the second coloring agent on the surface layer comprises: dissolving a resin composition containing the second coloring agent, polyvinyl butyral, a polyester resin, and a curing agent for film formation into a solvent, followed by coating the solvent onto the surface layer.

Specific embodiment 15 is the method according to specific embodiment 13 or 14, wherein the coating method includes blade coating, slit coating, and screen roller coating. Specific embodiment 16 is the method according to any one of specific embodiments 12 to 15, wherein a laser source for the laser-etching is a CO₂, Nd-YAG, or UV laser source.

### EXAMPLES

Examples and Comparative examples provided hereinafter facilitate the understanding of the present invention, and should not be constructed as limiting the scope of the present invention. Unless otherwise indicated, all parts and percentages used herein are by weight. Names (trade names) and suppliers of raw materials used in the Examples and Comparative examples of the present disclosure are listed in the following Table 1.

TABLE 1

| Name | Supplier |
|---|---|
| Polyvinyl butyral B16H | Kuraray Co., Ltd. |
| Saturated polyester resin SN | DSM Corporation |
| Cymel 325 (Melamine resin) | Cytec Industries Corporation |
| Black pulp solution LM067 | ISL Corporation |
| White titanium slurry R960 | Dupont China Co., Ltd. |
| Xylene | Sinopharm Chemical Reagent |
| | Co., Ltd. |
| Butanol | Sinopharm Chemical Reagent |
| | Co., Ltd. |
| Polyethylene terephthalate film | Siliconature (Jiangxi) New |
| Silphan S50m | Material Co., Ltd. |
| Acrylic pressure-sensitive adhesive | Changxing Chemical Co., |
| solution SM30 (solid content 45%) | Ltd. |
| Curing crosslinker L-75 (Toluene | Covestro Corporation |
| diisocyanate-based aromatic | |
| polyisocyanate, with a solid content | |
| of 75%) | |
| Silicon release paper | Loparex China Co., Ltd. |

### Example 1

Preparation of a Laser-Markable Article with Customized Watermarks

Various chemical components as described in Table 2 were successively added in proportion into a mixed solution of xylene and butanol; fully stirred until the various chemical components were completely dissolved, and mixed uniformly. The mixture solution was coated in a manner of blade coating onto a transparent polyethylene terephthalate film Silphan S50m (abbreviated as a carrier film hereafter) coated with a silicon release layer.

Then the above mixture on the carrier film was oven-dried at a condition of 180° to prepare a black surface layer. The coated black surface layer had a dried thickness of about 10 μm.

TABLE 2
Composition and proportion of the
mixture of the black surface layer

| Composition | Proportion |
|---|---|
| Polyvinyl butyral B16H | 35 g |
| Saturated polyester resin SN | 35 g |
| Cymel 325 | 17 g |
| Black pulp solution LM067 | 22 g |
| Xylene | 30 g |
| Butanol | 35 g |

The various chemical components as described in Table 3 were successively added in proportion into a mixed solution of xylene and butanol; fully stirred until the various chemical components were completely dissolved, and mixed uniformly. The mixture was coated in a manner of blade coating onto the black surface layer on the above carrier film. Then the above mixture solution was completely dried at 180° to produce a dried white bottom layer. The white surface layer had a dried thickness of about 50 μm. Thus, a black bottom layer and a white surface layer were obtained with the carrier film.

TABLE 3
Composition and proportion of the white bottom layer

| Composition | Proportion |
|---|---|
| Polyvinyl butyral B16H | 35 g |
| Saturated polyester resin SN | 35 g |
| Cymel 325 | 17 g |
| White titanium slurry R960 | 12 g |
| Xylene | 30 g |
| Butanol | 35 g |

The curing crosslinker L-75 (solid content 75%) was added at a ratio by weight of 0.8% into 100 g of the acrylic pressure-sensitive adhesive solution SM30 (solid content 45%), and mixed uniformly. Subsequently, the mixed pressure-sensitive adhesive solution was coated in a manner of blade coating onto a silicon release paper with a grammage of 90 gram/square meter (Loparex China Co., Ltd.). The pressure-sensitive adhesive was completely dried at 120°; and the dry adhesive thickness was controlled at about 26 gram/square meter. The produced silicon release paper with the pressure-sensitive adhesive was combined with the aforementioned carrier film with the black surface layer and the white bottom layer by contacting the pressure-sensitive adhesive layer with the white bottom layer; and the carrier film was stripped off while the combination was performed.

The above prepared sample was placed on a laser marking apparatus, with the black surface layer facing upwards to etch customized watermarks, wherein a laser-etching apparatus with a Spruce-355 UV laser source (Wuhan Chemical Laser Technology Co., Ltd.) was employed to etch the sample. The black surface layer had an etch depth of about 6 μm. The spacing among the etched points constituting the watermark units was about 0.07 mm.

Property Evaluation

(1) Abrasion Resistance

The sample prepared in Example 1 was placed on a Taber abrasion tester (provided by Taber Corporation). A CS-10 abrasion wheel (provided by Taber Corporation) was selected and a 500-g weight was loaded (provided by Taber Corporation). The sample was subjected to abrasion and the number of abrasion cycles was recorded until the appearance was blurry and could not be identified. The prepared sample could withstand 280 abrasion cycles or more. The number of abrasion cycles was far higher than that of the customized watermarks prepared by a current method such as printing (generally less than 80 times), which is several times higher. FIG. 3 shows the appearance of the sample prepared in Example 1 after the Taber abrasion resistance test.

(2) Solvent Resistance

A 1.5-kg weight was wrapped with a gauze (provided by Dupont China Co., Ltd.) with pure alcohol (provided by Sinopharm Chemical Reagent Co., Ltd.) dipped thereon. The sample prepared was subjected to abrasion cycles (back and forth); and an area that comes in contact between the gauze and the sample was a circle with a diameter of about 1 cm. After 400 times of the abrasion cycles, the appearance showed no changes, indicating that the sample is significantly superior to watermarks produced via printing or impression.

### Example 2

The sample prepared according to the method in Example 1 was placed on a laser-etching apparatus with a Spruce-355 UV laser source (Wuhan Chemical Laser Technology Co., Ltd.) to have customized watermarks etched thereon. The thickness of the black surface coating etched was controlled at about 7 μm; and the spacing among the etched points was controlled at about 0.21 mm. The sample was then obtained. The prepared sample was tested according to the method of property evaluation described in Example 1. In the aspect of abrasion resistance, the number of abrasion cycles could reach 280 or more; the number of chemical solvent abrasion cycles could reach 400; and the appearance showed no changes.

### Example 3

A sample was prepared according to the method in Example 1, and customized watermarks were etched on the sample prepared using a laser-etching apparatus with a CO₂ laser source (Han's Laser Technology Co., Ltd.). The thickness of the black surface coating etched was controlled at about 5 μm; the thickness of a portion of the bottom layer etched was controlled at 2 μm; and the spacing among etched points was controlled at about 0.35 mm, The sample was then obtained. The prepared sample was tested according to the method of property evaluation described in Example 1. In the aspect of abrasion resistance, the number of abrasion cycles could reach 280 or more; the number of chemical solvent abrasion cycles could reach 400; and the appearance showed no changes.

### Comparative Example 1

A sample was prepared according to the method in Example 1, and customized watermarks were etched on the sample prepared using a laser-etching apparatus with a CO₂ laser source (Han's Laser Technology Co., Ltd.). The thickness of the black surface coating etched was controlled at about 1.8 μm; and the spacing among etched points was controlled at about 0.35 mm, The sample was then obtained. The prepared sample was tested according to the method of property evaluation described in Example 1. In the aspect of abrasion resistance, when the number of abrasion cycles reached 170, information in the watermark unit became blurry and could not be identified. When the number of chemical solvent abrasion cycles reached 250, the appearance became blurry and information could not be identified easily.

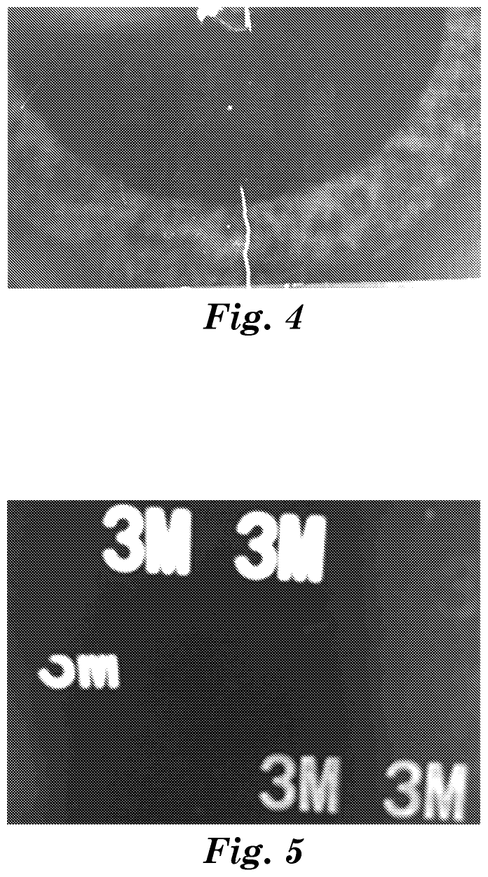

Results from the abrasion resistance test are shown in FIG. 4, wherein the watermarks were not present or could not be identified.

### Comparative Example 2

A sample was prepared according to the method in Example 1 and customized watermarks were etched on the sample prepared using a laser-etching apparatus with a CO₂ laser source (Han's Laser Technology Co., Ltd.). The total depth of the watermark units etched was controlled to exceed that of the black surface layer and reach the white bottom layer at a depth of about 20 μm. As shown in FIG. 5, all the watermark units in the sample of the example exhibited white backgrounds and black texts. According to the tests performed based on the method of property evaluation described in Example 1, although the abrasion resistance and chemical solvent resistance could achieve the same effects as Example 1, the area where the white watermark unit “3M” was located could not be subjected to a subsequent processing to have the main information of the vehicle itself written in.

For the purpose of illustration through examples, the above specific embodiments include many specific and concrete details. Nevertheless, it is to be understand by those of ordinary skill in the art that many variations, modifications, replacements and changes to these details shall all fall within the scope of the present disclosure as claimed in the specific embodiments. Therefore, the contents of the disclosure described in the embodiments are not intended to impose any limitations on the disclosure protected by the specific embodiments. The proper scope of the present disclosure should be defined by the following specific embodiments and proper legal equivalents thereof. All the cited literatures have each been incorporated into the present text through full text citation.

1. A laser-markable article with customized watermarks, comprising a surface layer containing a first coloring agent, a bottom layer containing a second coloring agent, an adhesive layer, and an optional release layer arranged consecutively in a stack, wherein
the laser-markable article further comprises customized watermarks arranged in the surface layer, the customized watermarks are comprised of a plurality of watermark units spaced apart from one another and regularly distributed in the surface layer, and each watermark unit is comprised of a laser-etched pattern with an etch depth of 2.5 μm to 25 μm.

2. The laser-markable article with customized watermarks according to claim 1, wherein
a depth of the watermark units is less than a thickness of the surface layer, or
a depth of a portion of the pattern in the watermark units is greater than the thickness of the surface layer but not more than the total thickness of the surface layer and the bottom layer, and an area of the pattern with a depth greater than the thickness of the surface layer accounts for not more than 20% in each watermark unit.

4. The laser-markable article with customized watermarks according to claim 1, wherein
the pattern of the watermark units is comprised of dots and/or lines, with a spacing between the dots being from 0 μm to 1.5 mm.

5. The laser-markable article with customized watermarks according to claim 1, wherein
the first coloring agent and the second coloring agent are two contrasting coloring agents.

6. The laser-markable article with customized watermarks according to claim 4, wherein
the first coloring agent is a black coloring agent, and the second coloring agent is a white coloring agent.

7. The laser-markable article with customized watermarks according to claim 1, wherein
the surface layer has a thickness of 2 μm to 25 μm.

8. The laser-markable article with customized watermarks according to claim 1, wherein
the bottom layer has a thickness of 30 μm to 100 μm.

9. The laser-markable article with customized watermarks according to claim 1, wherein
the surface layer and the bottom layer are formed with resin compositions comprised of a first coloring agent and a second coloring agent respectively.

10. The laser-markable article with customized watermarks according to claim 8, wherein
the resin compositions further comprise polyvinyl butyral, a polyester resin, and a curing agent for film formation.

11. The laser-markable article with customized watermarks according to claim 1, wherein
the adhesive layer is a pressure-sensitive adhesive layer.

12. The laser-markable article with customized watermarks according to claim 1, wherein the article is used as a label having a vehicle identification code.

13. A method for preparing the laser-markable article with customized watermarks according to claim 1, the method comprising:
laser-etching the surface layer of the laser-markable article to form customized watermarks, an etch depth is from 2.5 μm to 25 μm.

14. A method according to claim 12, wherein before laser-etching the surface layer of the laser-markable article, the method further comprises the following steps:
forming a surface layer containing a first coloring agent on a carrier film;
forming a bottom layer containing a second coloring agent on the surface layer;
forming an adhesive layer optionally with a release layer on the bottom layer; and
stripping off the carrier film.

15. The method according to claim 13, wherein
the forming of a surface layer of the first coloring agent on the carrier film comprises: dissolving a resin composition containing the first coloring agent, polyvinyl butyral, a polyester resin, and a curing agent for film formation into a solvent, followed by coating the solvent onto the carrier film.

16. The method according to claim 13, wherein
the forming of a bottom layer of the second coloring agent on the surface layer comprises: dissolving a resin composition containing the second coloring agent, polyvinyl butyral, a polyester resin, and a curing agent for film formation into a solvent, followed by coating the solvent onto the surface layer.

17. The method according to claim 14, wherein
the coating method includes blade coating, slit coating, and screen roller coating.

18. The method according to claim 12, wherein
a laser source for the laser-etching is a CO₂, Nd-YAG, or UV laser source.
